(19) United States
(12) Patent Application Publication
(10) Pub. No.: US 2025/0012597 A1
(43) Pub. Date: Jan. 9, 2025

(54) LANE-LEVEL DATA UPDATING METHOD, APPARATUS, DEVICE, READABLE STORAGE MEDIUM, AND PRODUCT

(71) Applicant: Baidu.com Times Technology (Beijing). Co., Ltd., Beijing (CN)

(72) Inventors: Hongfei ZHU, Beijing (CN); Wenyue Chen, Beijing (CN)

(21) Appl. No.: 18/887,513

(22) Filed: Sep. 17, 2024

(30) Foreign Application Priority Data
Jun. 13, 2024 (CN) 202410763974.9

(51) Int. Cl. G01C 21/00; G06V 20/56

(52) U.S. Cl. CPC G01C 21/3819; G01C 21/3859; G06V 20/588

(57) ABSTRACT

A lane-level data updating method, an apparatus, a device, a readable storage medium, and a product. The method includes: obtaining at least one kind of road association data corresponding to a target area; determining, based on the at least one kind of road association data and a preset parameter associated with the road association data, at least one area to be updated in which a lane change exists in the target area; obtaining, for each of the areas to be updated, a plurality of driving tracks corresponding to the area to be updated and a current road condition image; determining, based on the plurality of driving tracks and the current road condition image, target lane-level data corresponding to the area to be updated, and performing, based on the target lane-level data, an updating operation on pre-stored lane-level data.

### CROSS-REFERENCE TO RELATED APPLICATION

This application claims priority to Chinese Patent Application No. 202410763974.9, filed on Jun. 13, 2024, which is hereby incorporated by reference in its entirety.

### TECHNICAL FIELD

The present invention relates to intelligent transportation in data processing and, in particular, to a lane-level data updating method, an apparatus, a device, a readable storage medium and a product.

### BACKGROUND

With the continuous development of artificial intelligence technology, intelligent driving has gradually entered the life of users. As a typical application of intelligent driving, lane-level navigation can effectively improve driving experience of users. Lane-level data is an important dependency to support lane-level navigation, and data updating ability is a basic condition to keep the data fresh and ensure the navigation experience. Therefore, how to ensure the updating timeliness of lane-level data has become an urgent problem to be solved.

### SUMMARY

The present invention provides a lane-level data updating method, an apparatus, a device, a readable storage medium and a product, for quickly and accurately realizing lane-level data updating.

According to a first aspect of the present disclosure, a lane-level data updating method is provided, including:
obtaining at least one kind of road association data corresponding to a target area, where the road association data includes a road condition image, a driving track, and a standard map associated with the target area;
determining, based on the at least one kind of road association data and a preset parameter associated with the road association data, at least one area to be updated in which a lane change exists in the target area;
obtaining, for each of the areas to be updated, a plurality of driving tracks corresponding to the area to be updated and a current road condition image; and
determining, based on the plurality of driving tracks and the current road condition image, target lane-level data corresponding to the area to be updated, and performing, based on the target lane-level data, an updating operation on pre-stored lane-level data.

According to a second aspect of the present disclosure, an electronic device is provided, including:
at least one processor; and
a memory communicatively coupled to the at least one processor; where
the memory stores instructions executable by the at least one processor, and the instructions are executed by the at least one processor to enable the at least one processor to perform the method described in the first aspect.

According to a third aspect of the present disclosure, a non-transient computer readable storage medium storing computer instructions is provided, where the computer instructions are configured to enable a computer to perform the method described in the first aspect.

It should be understood that the content described in the section is not intended to identify key or important features of embodiments of the present disclosure, nor is it intended to limit the scope of the present disclosure. Other features of the present disclosure will be readily understood by the following specification.

### BRIEF DESCRIPTION OF DRAWINGS

The accompanying drawings are used for a better understanding of the present solutions and do not constitute a limitation of the present disclosure. Among them:

FIG. 1 is a system architecture on which the present disclosure is based.

FIG. 2 is a schematic flowchart of a lane-level data updating method provided by an embodiment of the present disclosure.

FIG. 3 is a schematic diagram of an application scenario provided by an embodiment of the present disclosure.

FIG. 4 is a schematic flowchart of a lane-level data updating method provided by another embodiment of the present disclosure.

FIG. 5 is a schematic flowchart of a lane-level data updating method provided by another embodiment of the present disclosure.

FIG. 6 is a schematic flowchart of a lane-level data updating method provided by another embodiment of the present disclosure.

FIG. 7 is a schematic diagram of an aggregated track provided by an embodiment of the present disclosure.

FIG. 8 is a schematic diagram of an aggregated track image provided by an embodiment of the present disclosure.

FIG. 9 is a schematic diagram of a cropped aggregated track image provided by an embodiment of the present disclosure.

FIG. 10 is a schematic diagram of a structure of a lane-level data updating apparatus provided by an embodiment of the present disclosure.

FIG. 11 is a schematic diagram of a structure of an electronic device provided by an embodiment of the present disclosure.

### DESCRIPTION OF EMBODIMENTS

Exemplary embodiments of the present disclosure are described below in conjunction with the accompanying drawings, which include various details of the embodiments of the present disclosure in order to help understanding, and which should be considered merely exemplary. Accordingly, one of ordinary skill in the art should recognize that various changes and modifications can be made to the embodiments described here without departing from the scope and spirit of the present disclosure. Similarly, descriptions of well-known features and structures are omitted from the following description for the sake of clarity and brevity.

With the continuous development of artificial intelligence technology, intelligent driving gradually enters life of users. As a typical application of intelligent driving, lane-level navigation can effectively improve driving experience of users. Lane-level data is an important dependency to support lane-level navigation, and data updating capability is a basic condition to keep the data fresh and ensure the navigation experience.

In related technology, the collection operation of lane image data is generally performed by a professional data collection vehicle, and the data processing operation is performed by a combination of automation and manual operation to achieve lane-level data updating. However, due to the limited number of professional data collection vehicles and the long data collection period, the lane-level data updating operation using the above method tends to be less timely and cannot meet the high timeliness requirement of intelligent driving.

In the process of solving the above technical problem, the inventor found through research that in order to achieve lane-level data updating in a fast and low-cost way, in combination with at least one road association data, such as a standard map, a road condition image, and a driving track, and based on the at least one road association data and a preset parameter associated with each road association data, at least one area to be updated where a current lane change occurs can be determined. Based on a plurality of driving tracks of the area to be updated and the current road condition image, the updated lanes and the lane widths of each lane in the area to be updated are accurately determined, and then the updating of the existing lane-level data can be realized based on the lane-level data of the area to be updated, so as to ensure that the lane-level data is fresh, and to provide data support for intelligent driving.

The present disclosure provides a lane-level data updating method, an apparatus, a device, a readable storage medium and a product for application to intelligent transportation in the field of data processing to achieve the effect of quickly and accurately performing data updating of lane-level data to keep the lane-level data fresh.

It should be noted that the human header model in the embodiment is not a human header model for a particular user and does not reflect the personal information of a particular user. It should be noted that the 2D face image in the present embodiment is from a publicly available dataset.

The collection, storage, use, process, transmission, provision and disclosure of the user's personal information involved in the technical solutions of the present disclosure are handled in compliance with relevant laws and regulations, and are not contrary to public order and morals.

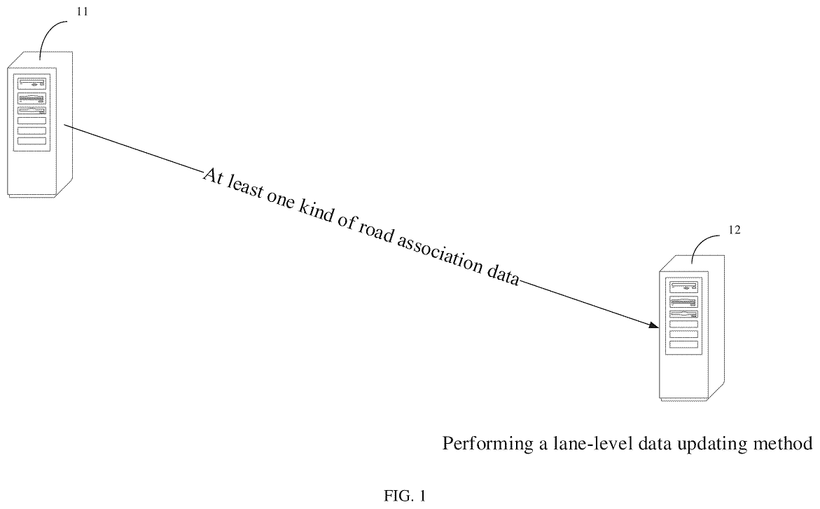

In order to enable readers to have a deeper understanding of realization principle of the present disclosure, the embodiments of the present disclosure are further refined in conjunction with the following FIG. 1-FIG. 11.

FIG. 1 is a system architecture on which the present disclosure is based, and as shown in FIG. 1, the system architecture on which the present disclosure is based includes at least a data server 11 and a server 12, where the server 12 may be provided with a lane-level data updating apparatus. The lane-level data updating apparatus may be written in a language such as C/C++, Java, Shell, or Python. The data server 11, on the other hand, may be a cloud server or a cluster of servers in which a large amount of data is stored.

Based on the above system architecture, the data server 11 stores road condition images, driving tracks, and standard maps associated with a target area. Among them, the road condition images may be collected by a socialized vehicle and uploaded to the data server 11 for storage. The driving tracks may be the driving tracks of the user when using the map software, which is obtained and stored in the data server 11 with the full authorization of the user.

Optionally, the server 12 may obtain the at least one kind of road association data from the data server 11, and determine at least one kind of area to be updated in which the target area is currently changing based on the at least one kind of road association data. If the at least one kind of area to be updated presents, a plurality of driving tracks corresponding to the area to be updated and a current road condition image may be obtained, and based on the plurality of driving tracks and the current road condition image, the obtaining of lane-level data of the area to be updated may be accurately carried out, thereby realizing the timely updating of the lane-level data.

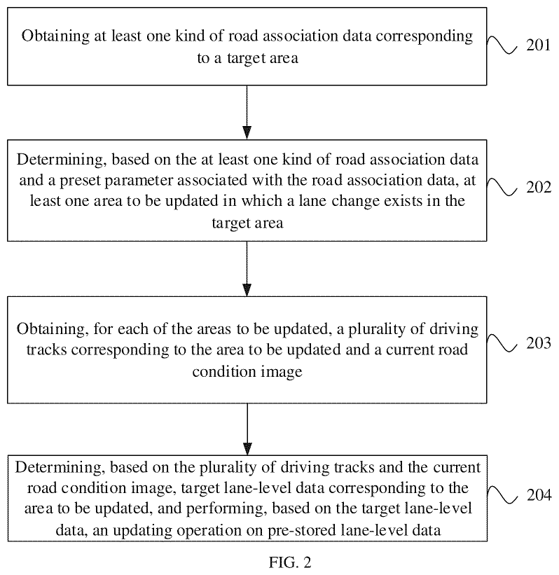

FIG. 2 is a schematic flowchart of a lane-level data updating method provided by an embodiment of the present disclosure, as shown in FIG. 2, the method includes:

Step 201, obtaining at least one kind of road association data corresponding to a target area, where the road association data includes a road condition image, a driving track, and a standard map associated with the target area.

The executing entity of the embodiment is a lane-level data updating apparatus. The lane-level data updating apparatus may be coupled in a server. The server may be communicatively connected with a data server so as to be able to obtain at least one kind of road association data from the data server, and then perform a discovery of a lane change and an updating operation of the lane-level data based on the at least one kind of road association data.

In the implementation, in order to achieve the lane-level data updating, it is first necessary to determine that a lane in which the update currently exists. And since the number of professional data collection vehicles is limited and the data collection period is long, in order to improve the efficiency of the lane-level data updating, at least one kind of road association data may be used to determine whether a lane change currently occurs.

Optionally, the at least one kind of road association data associated with the target area may be obtained, where the road association data includes a road condition image, a driving track, and a standard map collected by the socialized vehicle associated with the target area. The standard map data may be a map compiled according to the national interface drawing standards of China and other countries in the world, which has a high updating timeliness. The number of the socialized vehicles is large and the socialized vehicles are widely distributed, and a large number of road images can be collected based on the socialized vehicles. The driving track may be a vehicle driving track obtained after full authorization by the user. The above at least one kind of road association data tends to be low-cost and wide-covering, and based on the at least one kind of road association data, an area where the lane update currently exists can be accurately determined.

Step 202, determining, based on the at least one kind of road association data and a preset parameter associated with the road association data, at least one area to be updated in which a lane change exists in the target area.

In the embodiment, after obtaining the at least one road association data, the at least one area to be updated in which the lane change exists in the target area may be determined based on the at least one road association data. Among them, the determination of the at least one area to be updated may be achieved based on the first standard map data and/or the plurality of road condition images and/or the plurality of first driving track data.

Optionally, in order to improve the accuracy of the lane changing discovery, preset parameters associated with the road association data may be preset for different road association data. Where, the preset parameters include, but are not limited to, a priority parameter of the road association data and a weight parameter of the road association data.

Taking the preset parameter as the weight parameter as an example, different road association data may have different weight parameters correspondingly. After obtaining the at least one kind of road association data respectively, different lane changing contents may have different confidence correspondingly based on the lane changing contents corresponding to the at least one kind of road association data. A weighting operation is performed based on the confidence and the weight parameter, so as to jointly determine whether a lane change currently exists based on the at least one kind of road association data. By combining the at least one road association data, the lane changing discovery is performed, thus the accuracy and timeliness of the lane changing discovery can be improved.

Step 203: obtaining, for each of the areas to be updated, a plurality of driving tracks corresponding to the area to be updated and a current road condition image.

In the embodiment, after determining the at least one area to be updated, for each area to be updated, updated lane-level data corresponding to the area to be updated needs to be determined. Therefore, it is first necessary to obtain a plurality of driving tracks corresponding to the area to be updated and the current road condition image.

Where, the driving tracks may be obtained when the user is using the map software, after a full authorization by the user.

For example, when the user navigates from place A to place B using the map software, a prompting message may be sent to the user. Where, sending the prompting message to the user may be, for example, by way of a pop-up window, and the pop-up window may present a prompting message in the form of text. In addition, the pop-up window may contain a selection control for the user to select “agree” or “disagree” to provide personal information to the electronic device. When the user's consent to provide the driving track is obtained, the driving track is obtained.

It can be understood that the above notification and user authorization process are only schematic and do not limit the implementation of the present disclosure, and other methods that satisfy the relevant laws and regulations may also be used in the implementation of the present disclosure.

As an implementable way, a threshold the number of the driving tracks to be obtained may be preset. As the driving tracks are accumulated, when the number of current driving tracks is detected to reach the threshold of the number, the lane-level data is determined based on a plurality of driving tracks matching the threshold of the number.

It can be understood that after setting the threshold of the number of the driving tracks, the time period for obtaining the driving tracks may be different for different areas. For example, for areas with high traffic flow, a plurality of driving tracks matching the threshold of the number can be obtained in hour-level duration. On the contrary, for areas with low traffic flow, the acquisition of a plurality of driving tracks may take days.

Step 204: determining, based on the plurality of driving tracks and the current road condition image, target lane-level data corresponding to the area to be updated, and performing, based on the target lane-level data, an updating operation on pre-stored lane-level data.

In the implementation, the target lane-level data associated with the area to be updated may be determined based on the plurality of driving tracks and the current road condition image, where the target lane-level data may include some lanes where the update occurs in the area to be updated, as well as data such as the width of the lanes. For example, some lanes currently added to the area to be updated may be determined based on the plurality of driving tracks and the current road condition image, as well as the current lane number in the area to be updated, and the width of each of the lanes, etc.

After obtaining the target lane-level data, an updating operation may be performed on the pre-stored lane-level data based on the target lane-level data. For example, difference data between the pre-stored lane-level data and the target lane-level data may be determined, and the difference portion may be supplemented. Alternatively, the pre-stored lane-level data may be corrected based on the target lane-level data, etc., and the present disclosure is not limited thereto.

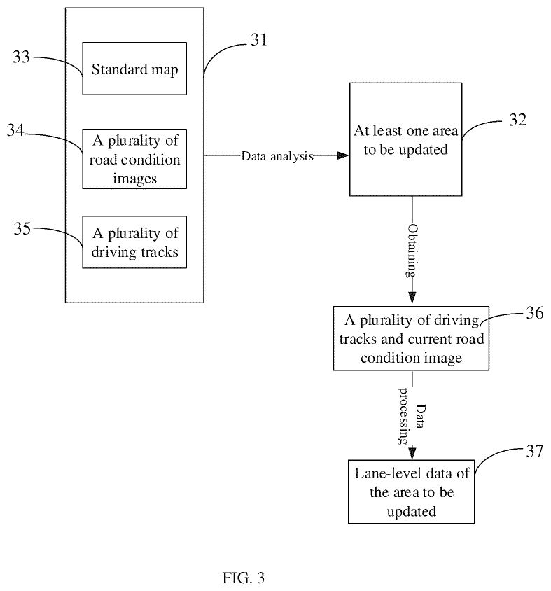

FIG. 3 is a schematic diagram of an application scenario provided by an embodiment of the present disclosure, as shown in FIG. 3, after obtaining the at least one kind of road association data 31, at least one area to be updated 32 in which a lane change exists in the target area can be determined based on the at least one kind of road association data 31. Among them, the at least one kind of road association data 31 includes a standard map 33, a plurality of road condition images 34 of the target area collected by a plurality of preset socialized vehicles, and a plurality of driving tracks 35 associated with the target area. A plurality of driving tracks corresponding to the area to be updated 32 and a current road condition image 36 are obtained. The lane-level data 37 corresponding to the area to be updated 32 is determined based on the plurality of driving tracks and the current road condition image 36, and an updating operation is performed on the existing lane-level data based on the lane-level data 37.

The lane-level data updating method provided in the embodiment, by obtaining at least one road association data corresponding to the target area, can accurately determine at least one area to be updated where a lane change currently occurs based on the at least one road association data and the preset parameter associated with each of the road association data. By joining the at least one road association data for the discovery of the lane changing, the accuracy as well as the timeliness of the lane changing discovery can be improved. Further, the lane-level data in the area to be updated can be accurately determined based on a plurality of the driving tracks of the area to be updated and the current road condition image, which in turn can update existing lane-level data based on the lane-level data of the area to be updated, so as to ensure that the data of the lane-level data is fresh, and to provide data support for the intelligent driving.

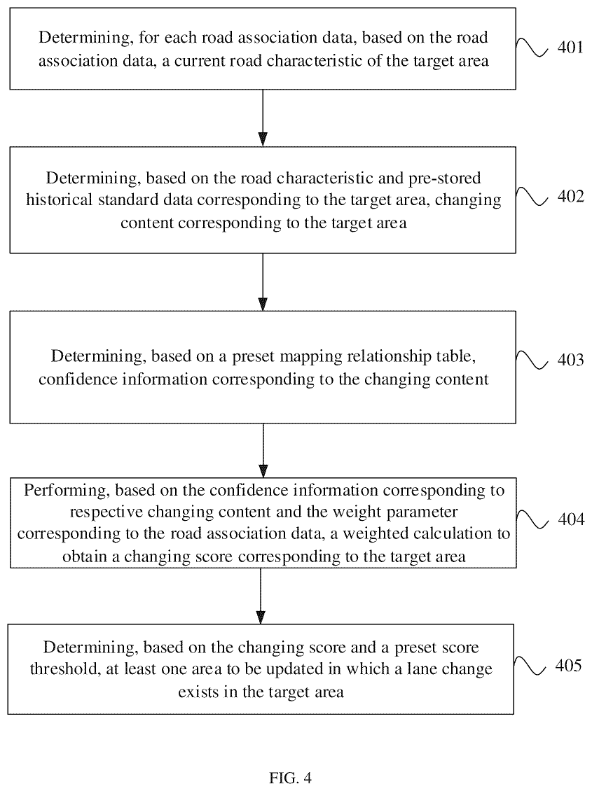

FIG. 4 is a schematic flowchart of a lane-level data updating method provided in yet another embodiment of the present disclosure, where, based on any of the above embodiments, the preset parameters associated with the road association data include a weight parameter. As shown in FIG. 4, step 202 includes:
Step 401, determining, for each road association data, based on the road association data, a current road characteristic of the target area.
Step 402, determining, based on the road characteristic and pre-stored historical standard data corresponding to the target area, changing content corresponding to the target area.
Step 403, determining, based on a preset mapping relationship table, confidence information corresponding to the changing content, where the mapping relationship table includes a mapping relationship between a plurality of changing contents and the confidence.
Step 404, performing, based on the confidence information corresponding to respective changing content and the weight parameter corresponding to the road association data, a weighted calculation to obtain a changing score corresponding to the target area.
Step 405: determining, based on the changing score and a preset score threshold, at least one area to be updated in which a lane change exists in the target area.

In the embodiment, the preset parameters associated with the road association data include the weight parameter. Different road association data may correspond to different weight parameters. For example, the weight parameter corresponding to the road condition image may be 60%, the weight parameter corresponding to the driving track may be 30%, and the weight parameter corresponding to the standard map may be 10%. Alternatively, the weight parameters corresponding to different road association data may be adjusted according to actual needs, and the present disclosure is not limited thereto.

For each road association data, a current road characteristic of the target area is determined based on the road association data. Among them, the road characteristic may be a characteristic representing the direction, width, flux, and the like of the road in the target area. For example, when the road association data is a road condition image, the road characteristic may be one or more of the number of lanes, a lane direction, a lane position, and a lane obstruction. When the road association data is a driving track, the road characteristic may be a drivable width and/or a driving flux and/or a driving direction.

Further, after determining the road characteristic corresponding to each road association data, the changing content corresponding to the target area may be determined based on the road characteristic and the pre-stored historical standard data corresponding to the target area. For example, a comparison operation may be performed between the road characteristic and the historical standard data to determine a portion of the road characteristic that differs from the historical standard data as the changing content. Where the historical standard data includes, but is not limited to, pre-stored lane-level data, historical driving tracks, historical standard maps, and the like.

Optionally, in order to achieve timely and accurate discovery of lane change, a mapping relationship table may be preset, where the mapping relationship table includes the mapping relationship between a plurality of changing contents and the confidence. Different changing contents may correspond to different confidence. For example, when the road association data is a road condition image, based on the road characteristic corresponding to the road condition image, current changing content can be determined to include, but is not limited to, a lane arrow change, a construction/speed limit change, an obstruction change, no change, and the like. Among them, since the lane arrow change can clearly represent that there is a change in the current lane, the confidence corresponding to the lane arrow change can be 0.5, the construction/speed limit change can represent that there may be a change in the lane in a short period of time, therefore, the confidence corresponding to the construction/speed limit change can be 0.3, and the obstruction change may be a temporary obstruction that has little impact on the overall change of the lane, therefore, the confidence corresponding to the obstruction change can be 0.2, while the confidence corresponding to no change can be 0.

It can be understood that the greater the impact of the changing content on the lane, the higher the corresponding confidence.

Therefore, after determining the changing content corresponding to the road correlation data respectively, the confidence corresponding to each changing content can be determined based on the mapping relationship table.

A weighted calculation is performed based on the confidence information corresponding to each changing content and the weight parameter corresponding to the road association data to obtain a changing score corresponding to the target area. The changing score jointly determined based on the at least one kind of road association data is compared with a preset score threshold, and based on the comparison result, at least one area to be updated in which a lane change exists in the target area is further determined.

The lane-level data updating method provided in the embodiment, by presetting weight information corresponding to different road association data, determines whether a lane change currently occurs based on the weight information and the confidence of the changing content corresponding to each road association data. Thereby, the discovery of lane changes can be carried out jointly with at least one kind of road association data, and the accuracy as well as the timeliness of the lane changing discovery of can be improved.

Optionally, on the basis of any of the above embodiments, step 405 includes:
if the changing score is greater than the score threshold, determining a target changing content in the changing content that meets a preset filtering condition, and taking an area corresponding to the target changing content as the area to be updated; or
the changing score is less than the score threshold, determining that an area to be updated in which a lane changes does not exist currently in the target area.

In the embodiment, after the weighted calculation is performed based on the weight information and the confidence of the changing content corresponding to each road association data to obtain a changing score corresponding to the target area, the changing score may be compared with a preset score threshold to determine whether a lane change currently occurs in the target area. Where, the score threshold may be adjusted based on actual needs, and the present disclosure is not limited thereto.

Optionally, if the changing score is greater than the score threshold, a target changing content in the changing content that meets the preset filtering condition is determined, and the area corresponding to the target changing content is taken as the area to be updated. Thereby, the lane-level data can be subsequently updated for the area to be updated. Otherwise, if the changing score is less than the score threshold, it is determined that an area to be updated in which a lane changes does not exist currently in the target area. At this point, there can be no need to update the lane-level data for the target area.

The lane-level data updating method provided in the embodiment, by presetting a score threshold, can accurately determine whether or not a lane updating operation is currently required based on the changing score corresponding to the target area and the score threshold, which improves the accuracy as well as the timeliness of the lane-level data updating.

Optionally, on the basis of any of the above embodiments, the road associated data includes a road condition image: step 401 includes:
determining lane description information corresponding to each lane in the road condition image, where the lane description information includes one or more of the number of lanes in the road condition image, position information between each lane and a socialized vehicle used for data collection, and obstacle information corresponding to each lane; and
determining whether accuracy of the lane description information corresponding to any one of the target lanes not satisfying a preset condition exists in the target area based on the lane description information.

If the accuracy of the lane description information corresponding to any one of the target lanes not satisfying the preset condition exists in the target area, obtaining the road condition image continues, and the lane description information, of which the accuracy satisfies a preset condition, corresponding to the target lane is determined, until each lane in the target area satisfies the preset condition, and the road characteristic is determined based on the lane description information, of which the accuracy satisfies a preset condition, corresponding to each lane, where the road characteristic includes one or more of the number of lanes, a lane direction, a lane position, and a lane obstruction.

In the embodiment, the road association data may include a road condition image. When the road condition image is obtained, the lane description information corresponding to each lane in the road condition image may be determined, where the lane description information includes one or more of the number of lanes in the road condition image, position information between each lane and a socialized vehicle used for data collection, and obstacle information corresponding to each lane.

It should be noted that the road condition image may be collected by the socialized vehicle and sent to the lane-level data updating apparatus. Alternatively, the road condition image may be collected by the socialized vehicle, sent to the data server, and obtained by the lane-level data updating apparatus from the data server. After obtaining the road condition image, the lane-level data updating apparatus may perform an identification operation on the lane description information corresponding to the road condition image based on a preset identification algorithm.

Alternatively, the identification algorithm may be pre-integrated in the socialized vehicle. After collecting the road condition image, the socialized vehicle may perform an identification operation on the lane description information corresponding to the road condition image based on the identification algorithm, and send the lane description information to the lane-level data updating apparatus. The present disclosure does not limit the executing entity of the identification operation of the road condition image.

Further, as the socialized vehicle is moving, there may be other vehicles on either side of it, or there may be a blind spot in the viewing angle. Therefore, it may not be possible to accurately determine a road characteristic based on the road condition image collected by a single socialized vehicle. Therefore, after obtaining the lane description information, it can be determined whether accuracy of the lane description information corresponding to any one of the target lanes does not satisfy a preset condition exists in the target area based on the lane description information. Where, the preset condition may be that the lanes on both sides of the vehicle are clear, the lane turning signs are clear, no obstruction is around the vehicle, and the like. The preset condition may be adjusted according to actual needs, and the present disclosure is not limited thereto.

If the accuracy of the lane description information corresponding to any of the target lanes does not satisfy the preset condition, it is represented that the road characteristic cannot be accurately obtained based on the current road condition image. Therefore, the road condition image can continue to be obtained, which can be collected and sent by other socialized vehicles. Based on the plurality of road condition images, the lane description information, of which the accuracy satisfies a preset condition, corresponding to the target lane is jointly determined, until each lane in the target area satisfies the preset condition, and the road characteristic is determined based on the lane description information corresponding to each lane of which the accuracy satisfies the preset condition, where the road characteristic includes one or more of the number of lanes, a lane direction, a lane position, and a lane obstruction.

The lane-level data updating method provided in the embodiment is able to improve the accuracy of the identified road characteristic by continuing to obtain other road condition images when the road characteristic cannot be accurately identified based on the currently obtained road condition image, and jointly determining the road characteristic based on the plurality of road condition images.

Further, on the basis of any of the above embodiments, the historical standard data includes historical lane-level data. Step 402 includes:
determining standard lane-level data matching the target area in the historical lane-level data; and
performing a comparison operation between the road characteristic and the standard lane-level data and determining the changing content based on a comparison result.

In the embodiment, the historical standard data may be historical lane-level data. The historical lane-level data may be the latest version of lane-level data in existence. When determining a current road characteristic within the target area based on the road condition image, standard lane-level data matching the target area may be determined in the historical lane-level data. A comparison operation is performed between the road characteristic and the standard lane-level data to determine whether the number of lanes, the lane direction, the lane position, and the lane obstruction in the current target area differ from the number of lanes, the lane direction, the lane position, and the lane obstruction in the historical lane-level data, and a comparison result is obtained. Further, the changing content can be determined based on the comparison result, for example, if the number of lanes in the current target area differs from the number of lanes in the historical lane-level data, it can be determined that there is a lane change in the current target area, and parameters such as the location of the newly added/reduced lanes can be further determined.

The lane-level data updating method provided in the present embodiment, by performing a comparison operation between the road characteristic determined based on the road condition image and the pre-stored historical lane-level data, can accurately determine the changing content in the target area, and then perform lane-level data updating operation based on the changing content.

Optionally, on the basis of any of the above embodiments, the road association data includes driving tracks within a preset time range. Step 401 includes:
performing a track aggregation operation on driving tracks to obtain an aggregated track corresponding to the target area;
identifying a drivable width and/or a driving flux and/or a driving direction corresponding to the aggregated track; and
determining the drivable width and/or the driving flux and/or the driving direction as the current road characteristic of the target area.

In the embodiment, the road association data includes the driving tracks within the preset time range, where the driving track data may be obtained with the full authorization of the user when the user is using the mapping software. The track aggregation operation is performed on the driving tracks to obtain an aggregated track corresponding to the target area. Where, the track aggregation operation may be a overlay aggregation operation so as to be able to aggregate the line-like driving tracks into a two-dimensional image. The drivable width and/or the driving flux and/or the driving direction corresponding to the aggregated track are identified. The drivable width and/or the driving flux and/or the driving direction are determined as the current road characteristic of the target area. Thus, the lane change in the current target area can be accurately determined based on the drivable width and/or the driving flux and/or the driving direction.

For example, if the drivable width increases, it may be a current lane addition. If the driving flux increases compared to the same time period in history, it may be a new lane.

The present embodiment provides a lane-level data updating method, by aggregating the driving tracks, can accurately determine a drivable width and/or a driving flux and/or a driving direction corresponding to the aggregated track based on the aggregated track, so as to accurately determine whether or not a lane change occurs at the present based on the drivable width and/or the driving flux and/or the driving direction.

Further, on the basis of any of the above embodiments, the historical standard data includes a historical driving track corresponding to the target area. Step 402 includes:
performing a comparison operation between the drivable width and/or driving direction and a historical drivable width and/or historical driving direction corresponding to the historical driving track, and determining the changing content based on a comparison result;
and/or, step 402 includes:
determining a collection time period corresponding to the driving track; and
performing a comparison operation between the driving flux and a historical driving flux of a same collection time period in history and determining the changing content based on a comparison result, where the historical driving flux is determined after performing a set operation on the historical driving track.

In the embodiment, the historical standard data includes a historical driving track corresponding to the target area. After obtaining a drivable width and/or a driving direction of the target area based on the identified driving track, a comparison operation can be performed between the drivable width and/or the driving direction and the historical drivable width and/or the historical driving direction corresponding to the historical driving track, so as to determine whether or not a changing content exists, and to obtain a comparison result. Then, the changing content can be determined based on the comparison result.

Optionally, a collection time period corresponding to the driving track may also be determined. A comparison operation is performed between the driving flux determined based on the driving track and the historical driving flux of the same collection time period in history, and the changing content is determined based on the comparison result, where the historical driving flux is determined after performing an set operation on the historical driving tracks.

It can be understood that if the current driving flux increases significantly compared to the driving flux of the same time period in history, there may be currently an increase in the number of lanes.

The lane-level data updating method provided by the present embodiment can accurately determine the changing content in the current target area by comparing road characteristic determined based on the driving track with the historical driving tracks.

Optionally, based on any of the above embodiments, the road association data includes a standard map. Step 401 includes:
identifying driving direction indication information and a topological relationship in the standard map; and
determining the driving direction indication information and the topological relationship as the road characteristics.

In the embodiment, the road association data may include the standard map, where the standard map is a map compiled based on the drawing standard for national boundaries in China and in countries around the world, and has an updating capability with high timeliness.

Further, after obtaining the standard map data, the driving direction indication information and the topological relationship in the standard map may be identified. The direction indication information may be arrow information drawn in the lanes. The topological relationship may accurately describe the connection relationship of the respective lanes. When a lane changes, the driving direction indication information and the topological relationship may change as well, so the driving direction indication information and the topological relationship can be identified as road characteristic. Therefore, whether a lane change occurs can be accurately determined based on the driving direction indication information and the topological relationship.

The lane-level data updating method provided in the embodiment, by identifying the driving direction indication information and the topological relationship in the standard map, and determining the driving direction indication information and the topological relationship as the road characteristic, may accurately determine whether or not a lane change currently occurs based on the driving direction indication information and the topological relationship, therefore improves the accuracy of lane-level data updating.

Further, on the basis of any of the above embodiments, the historical standard data includes a historical standard map. Step 402 includes:
performing a comparison operation between the standard map and the historical standard map to obtain a comparison result; and
determining a different portion between the standard map and the historical standard map in the comparison result as the changing content.

In the embodiment, in order to accurately determine whether a lane change exists in the current target area, a comparison operation is performed between the standard map and the historical standard map to obtain a comparison result. A different portion between the standard map and the historical standard map in the comparison result is determined as the changing content, where the different portion may be an increase/decrease in lanes, a change in topological relationship, and the like.

The lane-level data updating method provided in the embodiment obtains a comparison result by performing a comparison operation between the standard map and the historical standard map, and determines the different portion between the standard map and the historical standard map in the comparison result as the changing content. Therefore, whether a lane change currently occurs in the target area can be accurately determined, and the accuracy of the lane-level data updating is improved.

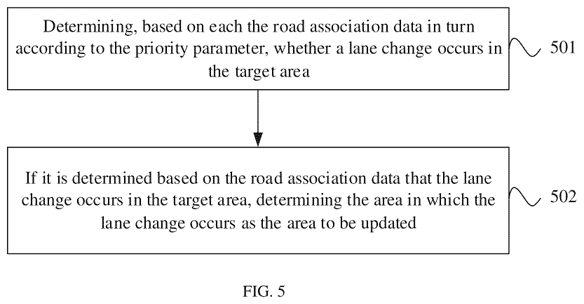

FIG. 5 is a schematic flowchart of a lane-level data updating method provided in yet another embodiment of the present disclosure, where on the basis of any of the above embodiments, the preset parameter associated with the road association data includes a priority parameter. As shown in FIG. 5, step 202 includes:
Step 501, determining, based on each road association data in turn according to the priority parameter, whether a lane change occurs in the target area.
Step 502, if it is determined based on the road association data that the lane change occurs in the target area, determining the area in which the lane change occurs as the area to be updated.

In the embodiment, the preset parameter associated with the road association data include the priority parameter, where different road association data may have different priority parameters correspondingly. For example, the priority of the road condition image is higher than the priority of the driving track, and the priority of the driving track is higher than the priority of the standard map.

Further, whether the lane change occurs in the target area may be determined based on each road association data in turn according to the priority parameter, where the scheme of determining whether the lane change occurs in the target area based on each road association data may be as in any of the above embodiments, and the present disclosure is not limited thereto. If the lane change occurs in the target area based on the road association data, the area in which the lane change occurs is determined as the area to be updated.

Following the above example, the priority of the road condition image is higher than the priority of the driving track, and the priority of the driving track is higher than the priority of the standard map. Whether a lane change occurs in the current target area may be determined preferentially based on the road condition image. If it is determined that no lane change occurs in the current target area based on the road condition image, whether a lane change occurs in the current target area may continue to be determined based on the driving track. If it is determined that no lane change occurs in the current target area based on the driving track, whether a lane change occurs in the current target area may continue to be determined based on the standard map. If a changing content exists in the standard map compared to the historical standard map, it can be determined that a lane change currently occurs.

On the contrary, if it is determined that the lane change occurs in the current target area based on the road condition image, it can be determined that the lane change occurs in the current target area, and the data processing for the driving track and the standard map with lower priorities can be no longer continued. Alternatively, if it is determined that the lane change occurs in the current target area based on the road condition image, in order to improve the accuracy of the data processing, at least one area to be updated where a change occurs in the target area may also be jointly determined based on the road condition image, the driving track, and the standard map. The present disclosure is not limited thereto.

The lane-level data updating method provided in the present embodiment, by presetting different priority parameters for different road association data, can accurately determine whether a lane change occurs in the current target area in accordance with the priority parameters, so as to improve the accuracy of lane changing discovery.

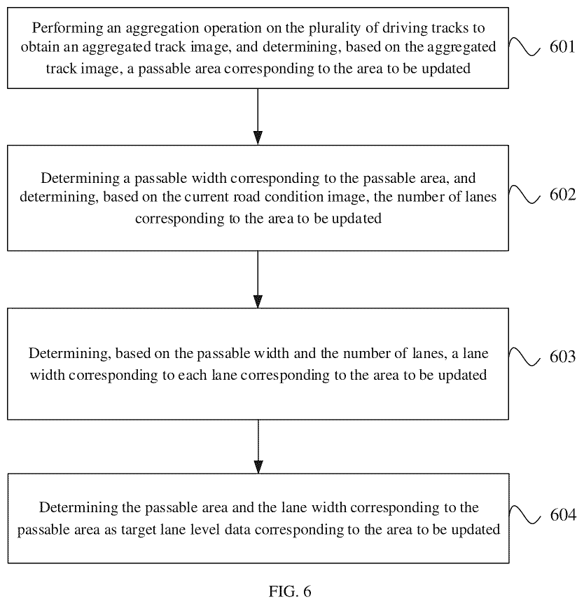

FIG. 6 is a schematic flowchart of a lane-level data updating method provided in yet another embodiment of the present disclosure, on the basis of any of the above embodiments, as shown in FIG. 6, step 203 includes:
Step 601, performing an aggregation operation on the plurality of driving tracks to obtain an aggregated track image, and determining, based on the aggregated track image, a passable area corresponding to the area to be updated.
Step 602, determining a passable width corresponding to the passable area, and determining, based on the current road condition image, the number of lanes corresponding to the area to be updated.
Step 603, determining, based on the passable width and the number of lanes, a lane width corresponding to each lane corresponding to the area to be updated.
Step 604, determining the passable area and the lane width corresponding to the passable area as target lane level data corresponding to the area to be updated.

In the embodiment, after obtaining the plurality of driving tracks corresponding to the area to be updated, an aggregation operation may be performed on the plurality of driving tracks to obtain an aggregated track, where the aggregation operation may be a overlay aggregation operation, and the line-like driving tracks may be transformed into a planar-like aggregated track image through the track aggregation operation. The passable area corresponding to the area to be updated is determined based on the aggregated track image.

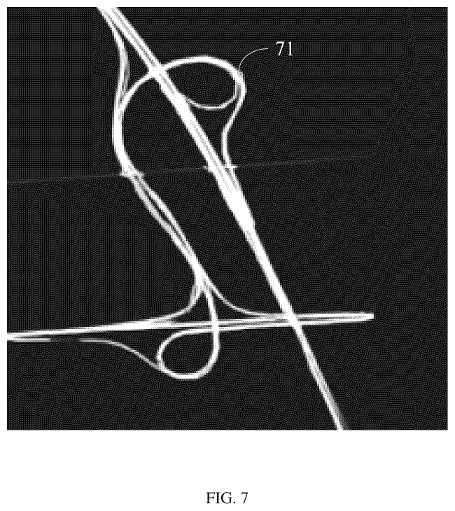

FIG. 7 is a schematic diagram of an aggregated track provided by an embodiment of the present disclosure, as shown in FIG. 7, since different vehicles tend to have different tracks during travelling, after aggregating a plurality of driving tracks, the passable area 71 corresponding to the area to be updated can be obtained.

Further, after an aggregation operation is performed on the plurality of historical driving tracks, a passable width corresponding to the passable area can also be accurately determined based on the aggregated track and the scaling size corresponding to the aggregated track.

In addition, after obtaining the historical road condition image, an identification operation may be performed on the number of lanes in the current road condition image, where an image identification operation may be performed on the current road condition image using a preset lane identification model to determine the number of lanes corresponding to the area to be updated.

Optionally, after respectively determining the passable width and the number of lanes corresponding to the passable area, since the lane widths usually tend to be the same, the lane width can be accurately determined based on the passable width and the number of lanes. Then the passable area and the lane width corresponding to the passable area can be determined as target lane-level data corresponding to the area to be updated.

Further, when updating the data based on the lane-level data, the passable area can be compared with the lanes in the existing lane-level data, and an updating operation can be performed on the portion of the lanes in which the change occurs.

The lane-level data updating method provided in the embodiment, by performing an aggregation operation on a plurality of driving tracks associated with the area to be updated, can accurately determine a passable area corresponding to the area to be updated on the basis of the aggregated track, and thus can accurately determine a lane width on the basis of the width of the passable area and the number of lanes which is obtained by identification based on the current road image identification, and obtain the target lane-level data.

Further, on the basis of any of the above embodiments, step 601 includes:
calculating an image gradient corresponding to the aggregated track image; and
performing, based on the image gradient, a cropping operation on an area of the aggregated track image that satisfies a preset cropping condition, to obtain the passable area.

In the embodiment, since the number of driving tracks is multiple, different drivers have different driving habits, and the actual driving situations are different, irregular driving tracks may exist in the plurality of driving tracks. The irregular driving tracks may lead to an unclear boundary of the aggregated track image, and thus the road width cannot be accurately determined.

Therefore, in order to improve the accuracy of the lane-level data updating, an image gradient corresponding to the aggregated track image may be calculated, where any one of the image gradient calculating methods may be used to achieve the image gradient calculation corresponding to the aggregated track image, and the present disclosure is not limited thereto. Based on the image gradient, a cropping operation is performed on an area in the aggregated track image that satisfies a preset cropping condition to obtain the passable area.

It should be noted that the image gradient is the rate of change of pixels (white, black) in the aggregated track image, and the maximum gradient is the place with the maximum rate of change, i.e., the road boundary. Therefore, the preset cropping condition may be that after determining the maximum gradient, the location of the maximum gradient is determined as the road boundary, and a cropping operation is performed on the portion outside the boundary.

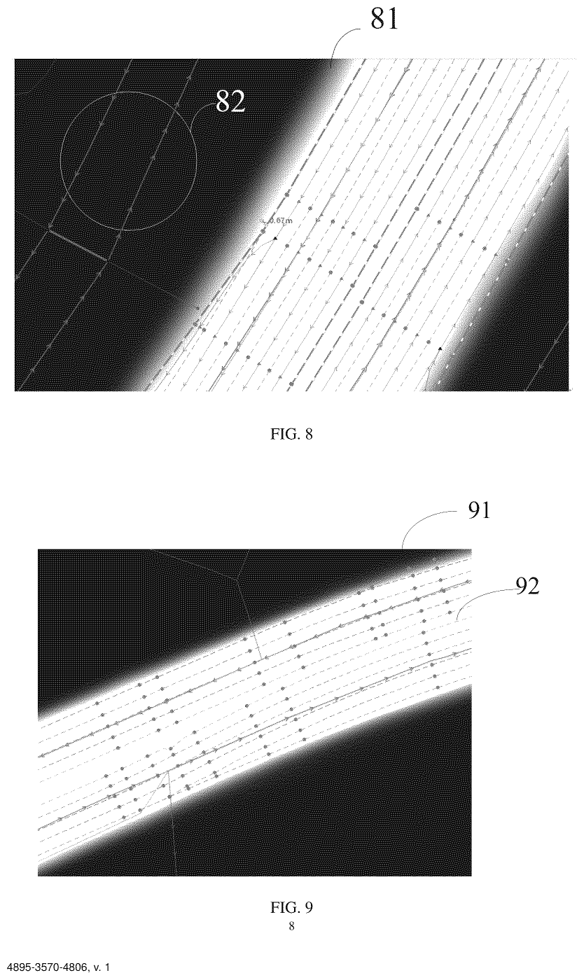

FIG. 8 is a schematic diagram of an aggregated track image provided by an embodiment of the present disclosure, as shown in FIG. 8, some abnormal tracks 82 exist in the aggregated track image 81. When the abnormal tracks 82 exist, the abnormal tracks 82 will cause a great obstacle to determine the road width, which will lead to a low accuracy rate of the road width determined based on the aggregated track image 81.

FIG. 9 is schematic diagram of a cropped aggregated track image provided by an embodiment of the present disclosure, as shown in FIG. 9, after determining the image gradient of the aggregated track image and cropping the aggregated track image based on the image gradient as well as the preset cropping condition, no abnormal track exists in the cropped aggregated track image 91, and thus the road width can be accurately determined based on the track aggregation area 92.

The lane-level data updating method provided in the embodiment may improve the accuracy of the aggregated track image by determining an image gradient of the aggregated track image and cropping the aggregated track image based on the image gradient as well as the preset cropping condition, and thus may improve the accuracy of the calculated road width.

Further, on the basis of any of the above embodiments, step 603 includes:
dividing the passable width equally according to the number of lanes, and determining the lane width corresponding to each of the lanes.

In the embodiment, when there are a plurality of lanes in a road, each lane generally has the same lane width. Therefore, after determining the width corresponding to the passable area and the number of lanes respectively, the passable width may be divided equally based on the number of lanes to determine the lane width corresponding to the lane.

For example, a width of the passable area of 10 meters may be determined based on the aggregated historical driving tracks. Based on the image identification of the historical road condition image, it can be determined that four lanes exist in the passable area. Therefore, the width of each lane can be obtained as 2.5 meters by calculating 10/4.

The lane-level data updating method provided by the present embodiment determines the lane width corresponding to the lane by dividing the passable width equally according to the number of the lanes, so that the lane width can be calculated accurately and the accuracy of the lane-level data can be improved.

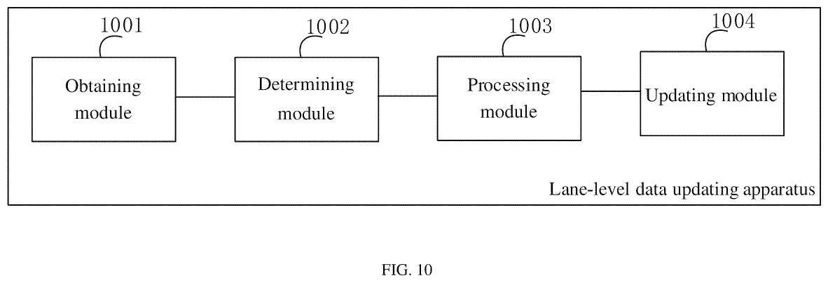

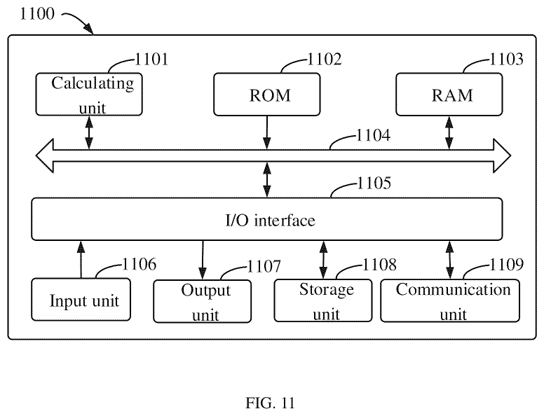

FIG. 10 is a schematic diagram of a structure of a lane-level data updating apparatus provided by an embodiment of the present disclosure, as shown in FIG. 10, the apparatus includes: an obtaining module 1001, a determining module 1002, a processing module 1003, and an updating module 1004. Among the modules, the obtaining module 1001 is configured to obtain at least one kind of road association data corresponding to a target area, where the road association data includes a road condition image, a driving track, and a standard map associated with the target area; the determining module 1002 is configured to determine at least one area to be updated in which a lane change exists in the target area based on the at least one kind of road association data and a preset parameter associated with the road association data; the processing module 1003 is configured to obtain a plurality of driving tracks corresponding to the area to be updated and a current road condition image for each of the areas to be updated; the updating module 1004 is configured to determine target lane-level data corresponding to the area to be updated based on the plurality of driving tracks and the current road condition image, and perform an updating operation on pre-stored lane-level data based on the target lane-level data.

Further, on the basis of any of the above embodiments, the preset parameters associated with the road association data include a weight parameter, where the determining module includes: a determining unit, configured to determine a current road characteristic of the target area for each road association data based on the road association data; an identification unit, configured to determine changing content corresponding to the target area based on the road characteristic and pre-stored historical standard data corresponding to the target area; a finding unit, configured to determine confidence information corresponding to the changing content based on a preset mapping relationship table, where the mapping relationship table includes a mapping relationship between a plurality of changing contents and confidence; a calculating unit, configured to perform, based on the confidence information corresponding to respective changing content and the weight parameter corresponding to the road association data, a weighted calculation to obtain a changing score corresponding to the target area; and a processing unit, configured to determine at least one area to be updated in which a lane change exists in the target area based on the changing score and a preset score threshold.

Further, on the basis of any of the above embodiments, where the processing unit includes: a first identification subunit, configured to determine, if the changing score is greater than the score threshold, a target changing content in the changing content that meets a preset filtering condition and take an area corresponding to the target changing content as the area to be updated; a second identification subunit, configured to determine, if the changing score is less than the score threshold, that an area to be updated in which a lane changes does not exist currently in the target area.

Further, on the basis of any of the above embodiments, the road association data includes the road condition image:
where the determining unit includes:
a determining sub-unit, configured to determine lane description information corresponding to each lane in the road condition image, where the lane description information includes one or more of the number of lanes in the road condition image, position information between each lane and a socialized vehicle used for data collection, and obstacle information corresponding to each lane;
a detection subunit, configured to determine whether accuracy of the lane description information corresponding to any one of the target lanes not satisfying a preset condition exists in the target area based on the lane description information; and
a processing subunit, configured to, if the accuracy of the lane description information corresponding to any one of the target lanes not satisfying a preset condition exists in the target area, continue to obtain the road condition image, determine the lane description information, of which the accuracy satisfies a preset condition, corresponding to the target lane, until each lane in the target area satisfies the preset condition, and determine the road characteristic based on the lane description information, of which the accuracy satisfies a preset condition, corresponding to each lane, where the road characteristic includes one or more of the number of lanes, a lane direction, a lane position, and a lane obstruction.

Further, on the basis of any of the above embodiments, the historical standard data includes historical lane-level data. The identification unit includes: a determining subunit, configured to determine standard lane-level data matching the target area in the historical lane-level data; a comparing subunit, configured to perform a comparison operation between the road characteristic and the standard lane-level data and determine the changing content based on a comparison result.

Further, on the basis of any of the above embodiments, the road association data includes driving tracks within a preset time range, where the determining unit includes: an aggregating subunit, configured to perform a track aggregation operation on driving tracks to obtain an aggregated track corresponding to the target area; an identification subunit, configured to identify a drivable width and/or a driving flux and/or a driving direction corresponding to the aggregated track; and a determining subunit, configured to determine the drivable width and/or the driving flux and/or the driving direction as the current road characteristic of the target area.

Further, on the basis of any of the above embodiments, the historical standard data includes a historical driving track corresponding to the target area. The identification unit includes: a comparing subunit, configured to perform a comparison operation between the drivable width and/or driving direction and a historical drivable width and/or historical driving direction corresponding to the historical driving track, and determine the changing content based on a comparison result. And/Or, the identification unit includes: a determining subunit, configured to determine a collection time period corresponding to the driving track; and a comparing subunit, configured to perform a comparison operation between the driving flux and a historical driving flux of a same collection time period in history and determine the changing content based on a comparison result, where the historical driving flux is determined after performing a set operation on the historical driving track.

Further, on the basis of any of the above embodiments, the road association data includes a standard map, where the determining unit includes: an identification subunit, configured to identify driving direction indication information and a topological relationship in the standard map; and a determining subunit, configured to determine the driving direction indication information and the topological relationship as the road characteristics.

Further, on the basis of any of the above embodiments, the historical standard data includes a historical standard map, where the identification unit includes: a comparing subunit, configured to perform a comparison operation between the standard map and the historical standard map to obtain a comparison result; and a determining subunit, configured to determine a different portion between the standard map and the historical standard map in the comparison result as the changing content.

Further, on the basis of any of the above embodiments, the preset parameter associated with the road association data includes a priority parameter, where the determining module includes: a determining unit, configured to determine whether a lane change occurs in the target area based on each road association data in turn according to the priority parameter; and a processing unit, configured to determine the area in which the lane change occurs as the area to be updated if it is determined based on the road association data that the lane change occurs in the target area.

Further, on the basis of any of the above embodiments, where the processing module includes:
an aggregating unit, configured to perform an aggregation operation on the plurality of driving tracks to obtain an aggregated track image, and determine a passable area corresponding to the area to be updated based on the aggregated track image;
a determining unit, configured to determine a passable width corresponding to the passable area, and determine the number of lanes corresponding to the area to be updated based on the current road condition image;
a calculating unit, configured to determine a lane width corresponding to each lane corresponding to the area to be updated based on the passable width and the number of lanes; and
a processing unit, configured to determine the passable area and the lane width corresponding to the passable area as target lane level data corresponding to the area to be updated.

Further, on the basis of any of the above embodiments, where the aggregating unit includes: a calculating subunit, configured to calculate an image gradient corresponding to the aggregated track image; and a cropping subunit, configured to perform, based on the image gradient, a cropping operation on an area of the aggregated track image that satisfies a preset cropping condition to obtain the passable area.

Further, on the basis of any of the above embodiments, where the calculating unit includes: a calculating subunit, configured to divide the passable width equally according to the number of lanes and determine the lane width corresponding to each of the lanes.

According to embodiments of the present disclosure, the present disclosure also provides an electronic device, a readable storage medium and a computer program product.

According to an embodiment of the present disclosure, the present disclosure further provides an electronic device, including:
at least one processor; and
a memory communicatively coupled to the at least one processor; where
the memory stores instructions executable by the at least one processor, and the instructions are executed by the at least one processor to enable the at least one processor to perform the method as described in any of the above embodiments.

According to an embodiment of the present disclosure, the present disclosure further provides a non-transient computer-readable storage medium storing computer instructions, where the computer instructions are configured to enable a computer to perform the method as described in any of the above embodiments.

According to an embodiment of the present disclosure, the present disclosure further provides a computer program product, and the computer program product includes a computer program, where the computer program is stored in a readable storage medium, at least one processor of an electronic device is able to read the computer program from the readable storage medium, and the at least one processor executes the computer program to cause the electronic device to perform the scheme as described in any of the above embodiments.

FIG. 11 is a schematic diagram of a structure of an electronic device provided by an embodiment of the present disclosure. Electronic device 1100 is intended to represent various forms of digital computers, such as, a laptop, a desktop computer, a workstation, a personal digital assistant, a server, a blade server, a mainframe, and other suitable computers. The Electronic device may also represent various forms of mobile devices, such as, a personal digital assistant, a cellular phone, a smart phone, a wearable device and other similar computing apparatuses. The components shown here, the connections and relationships, as well as the functions of the components, are shown as examples only and are not intended to limit the implementations of the present disclosure described and/or required here.

As shown in FIG. 11, the device 1100 includes a calculating unit 1101 that may perform various appropriate actions and processes according to a computer program stored in read-only memory (ROM) 1102 or loaded from a storage unit 1108 into random access memory (RAM) 1103. In the RAM 1103, various programs and data required for the operation of the device 1100 may also be stored. The calculating unit 1101, the ROM 1102, and the RAM 1103 are connected to each other via a bus 1104. Input/output (I/O) interface 1105 is also connected to the bus 1104.

A plurality of components of the device 1100 are connected to the I/O interface 1105, including: an input unit 1106, such as a keyboard, a mouse, etc.; an output unit 1107, such as various types of displays, speakers, etc.; a storage unit 1108, such as a disk, compact disc, etc.; and a communication unit 1109, such as a network card, a modem, a wireless communication transceiver, etc. The communication unit 1109 allows the device 1100 to exchange information/data with other devices via a computer network such as the Internet and/or various telecommunication networks.

The calculating unit 1101 may be a variety of general-purpose and/or dedicated processing components with processing and calculating capabilities. Some examples of calculating unit 1101 include, but are not limited to, central processing unit (CPU), graphics processing unit (GPU), various dedicated artificial intelligence (AI) computing chips, various computing units running machine learning model algorithms, digital signal processor (DSP), and any suitable processors, controllers, microcontrollers, and the like. The calculating unit 1101 performs the various methods and processes described above, such as the lane-level data updating method. For example, in some embodiments, the lane-level data updating method may be implemented as a computer software program that is tangibly contained in a machine-readable medium, such as the storage unit 1108. In some embodiments, some or all of the computer program may be loaded and/or installed on the device 1100 via the ROM 1102 and/or the communication unit 1109. When the computer program is loaded into RAM 1103 and executed by the calculating unit 1101, one or more steps of the lane-level data updating method described above may be performed. Alternatively, in other embodiments, the calculating unit 1101 may be configured to perform the lane-level data updating method by any other suitable means (e.g., with the aid of firmware).

Various implementations of the system and technique described above here may be implemented in a digital electronic circuit system, an integrated circuit system, a field-programmable gate array (FPGA), an application-specific integrated circuit (ASIC), an application-specific standard products (ASSP), a system of system-on-chip (SOC), a complex programmable logic device (CPLD), computer hardware, firmware, software, and/or combinations thereof. The various embodiments may include: implementation in one or more computer programs that may be executed and/or interpreted on a programmable system including at least one programmable processor, where the programmable processor may be a dedicated or general-purpose programmable processor that may receive data and instructions from the storage system, at least one input apparatus, and at least one output apparatus, and transmit the data and instructions to the storage system, the at least one input apparatus, and the at least one output apparatus.

Program code for implementing the method of the present disclosure may be written in any combination of one or more programming languages. The program code may be provided to a processor or controller of a general-purpose computer, a dedicated computer, or other programmable data processing apparatus which enables the program code when executed by the processor or controller to cause the functions/operations set in a flowchart and/or a block diagram to be implemented. The program code may be executed entirely on the machine, partially on the machine, partially on the machine as a stand-alone software package and partially on a remote machine, or entirely on a remote machine or server.

In the context of the present disclosure, a machine-readable medium may be a tangible medium that may contain or store a program for use by or in conjunction with an instruction executing system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of the machine-readable storage media include an electrical connection based on one or more wires, a portable computer disc, a hard disc, RAM, ROM, erasable programmable read-only memory (EPROM or flash memory), optical fiber, CD-ROM, an optical storage device, a magnetic storage device or any suitable combination of the foregoing.

To provide interaction with a user, the systems and techniques described here may be implemented on a computer having: a display apparatus (e.g., a cathode ray tube (CRT) monitor or liquid crystal display (LCD) monitor) for displaying information to the user; and a keyboard and a pointing apparatus (e.g., a mouse or a trackball) by which the user can provide input to the computer. Other types of apparatuses may also be used to provide interaction with the user; for example, the feedback provided to the user may be any form of sensing feedback (e.g., visual feedback, auditory feedback, or haptic feedback); and the input from the user may be received in any form, including acoustic input, voice input, or haptic input.

The system and technique described here may be implemented in a computing system that includes a back-end component (e.g., as a data server), or a computing system that includes a middleware component (e.g., an application server), or a computing system that includes a front-end component (e.g., a user's computer with a graphical user interface or a web browser through which a user can interact with implementations of the system and technique described here), or in a computing system that includes any combination of the back-end component, the middleware component, or the front-end component. The components of the system may be interconnected via digital data communication (e.g., a communication network) in any form or medium. Examples of communication network include: a local area network (LAN), a wide area network (WAN), and the Internet.

A computer system may include a client and a server. The client and the server are generally remote from each other and typically interact over a communication network. The client-server relationship is created by computer programs that run on corresponding computers and have a client-server relationship with each other. A server can be a cloud server, also known as a cloud computing server or cloud host, which is a host product in the cloud computing service system to solve the shortcomings that in traditional physical host and Virtual Private Server (VPS) service, management is difficult and business scalability is weak. The Server can also be a server for a distributed system, or a server that incorporates blockchain.

It should be understood that steps may be reordered, added or deleted using various forms of the process shown above. For example, the steps documented in the present disclosure may be performed in parallel or sequentially or in a different order, as long as the desired results of the technical solutions disclosed in the present disclosure can be achieved, and no limitation is made here.

The above specific embodiments do not constitute a limitation on the protection scope of the present disclosure. It should be understood by those skilled in the art that various modifications, combinations, sub-combinations, and substitutions may be made according to design requirements and other factors. Any modifications, equivalent substitutions, improvements, etc. made within the spirit and the principle of the present disclosure shall be included in the protection scope of the present disclosure.

What is claimed is:

1. A lane-level data updating method, comprising:
obtaining at least one kind of road association data corresponding to a target area, wherein the road association data comprises a road condition image, a driving track, and a standard map associated with the target area;
determining, based on the at least one kind of road association data and a preset parameter associated with the road association data, at least one area to be updated in which a lane change exists in the target area;
obtaining, for each of the areas to be updated, a plurality of driving tracks corresponding to the area to be updated and a current road condition image; and
determining, based on the plurality of driving tracks and the current road condition image, target lane-level data corresponding to the area to be updated, and performing, based on the target lane-level data, an updating operation on pre-stored lane-level data.

2. The method according to claim 1, wherein the preset parameter associated with the road association data comprises a weight parameter;
wherein the determining, based on the at least one kind of road association data and the preset parameter associated with the road association data, at least one area to be updated in which a lane change exists in the target area comprises:
determining, for each road association data, based on the road association data, a current road characteristic of the target area;
determining, based on the road characteristic and pre-stored historical standard data corresponding to the target area, changing content corresponding to the target area;
determining, based on a preset mapping relationship table, confidence information corresponding to the changing content, wherein the mapping relationship table comprises a mapping relationship between a plurality of changing contents and confidence;
performing, based on the confidence information corresponding to respective changing content and the weight parameter corresponding to the road association data, a weighted calculation to obtain a changing score corresponding to the target area; and
determining, based on the changing score and a preset score threshold, at least one area to be updated in which a lane change exists in the target area.

3. The method according to claim 2, wherein the determining, based on the changing score and a preset score threshold, at least one area to be updated in which a lane change exists in the target area comprises:
if the changing score is greater than the score threshold, determining a target changing content in the changing content that meets a preset filtering condition and taking an area corresponding to the target changing content as the area to be updated; or
if the changing score is less than the score threshold, determining that an area to be updated in which a lane changes does not exist currently in the target area.

4. The method according to claim 2, wherein the road association data comprises the road condition image:
wherein the determining, based on the road association data, a current road characteristic of the target area comprises:
determining lane description information corresponding to each lane in the road condition image, wherein the lane description information comprises one or more of the number of lanes in the road condition image, position information between each lane and a socialized vehicle used for data collection, and obstacle information corresponding to each lane; and
determining, based on the lane description information, whether accuracy of the lane description information corresponding to any one of the target lanes not satisfying a preset condition exists in the target area;
if the accuracy of the lane description information corresponding to any one of the target lanes not satisfying the preset condition exists in the target area, continuing to obtain the road condition image, determining the lane description information, of which the accuracy satisfies a preset condition, corresponding to the target lane, until each lane in the target area satisfies the preset condition, and determining the road characteristic based on the lane description information, of which the accuracy satisfies a preset condition, corresponding to each lane, wherein the road characteristic comprises one or more of the number of lanes, a lane direction, a lane position, and a lane obstruction.

5. The method according to claim 4, wherein the historical standard data comprises historical lane-level data; and
wherein the determining, based on the road characteristic and the pre-stored historical standard data corresponding to the target area, changing content corresponding to the target area comprises:
determining standard lane-level data matching the target area in the historical lane-level data; and
performing a comparison operation between the road characteristic and the standard lane-level data and determining the changing content based on a comparison result.

6. The method according to claim 2, wherein the road association data comprises a driving track within a preset time range; and
wherein the determining, based on the road association data, a current road characteristic of the target area comprises:
performing a track aggregation operation on driving tracks to obtain an aggregated track corresponding to the target area;
identifying a drivable width and/or a driving flux and/or a driving direction corresponding to the aggregated track; and
determining the drivable width and/or the driving flux and/or the driving direction as the current road characteristic of the target area.

7. The method according to claim 6, wherein the historical standard data comprises a historical driving track corresponding to the target area; and
wherein the determining, based on the road characteristic and the pre-stored historical standard data corresponding to the target area, changing content corresponding to the target area comprises:
performing a comparison operation between the drivable width and/or driving direction and a historical drivable width and/or historical driving direction corresponding to the historical driving track, and determining the changing content based on a comparison result; and/or
wherein the determining, based on the road characteristic and the pre-stored historical standard data corresponding to the target area, changing content corresponding to the target area comprises:
determining a collection time period corresponding to the driving track; and
performing a comparison operation between the driving flux and a historical driving flux of a same collection time period in history and determining the changing content based on a comparison result, wherein the historical driving flux is determined after performing a set operation on the historical driving track.

8. The method according to claim 2, wherein the road association data comprises a standard map; and
wherein the determining, based on the road association data, a current road characteristic of the target area comprising:
identifying driving direction indication information and a topological relationship in the standard map; and
determining the driving direction indication information and the topological relationship as the road characteristics.

9. The method according to claim 8, wherein the historical standard data comprises a historical standard map; and
wherein the determining, based on the road characteristic and the pre-stored historical standard data corresponding to the target area, changing content corresponding to the target area comprises:
performing a comparison operation between the standard map and the historical standard map to obtain a comparison result; and
determining a different portion between the standard map and the historical standard map in the comparison result as the changing content.

10. The method according to claim 1, wherein the preset parameter associated with the road association data comprises a priority parameter; and
wherein the determining, based on the at least one kind of road association data and the preset parameter associated with the road association data, at least one area to be updated in which a lane change exists in the target area, comprising:
determining, based on each road association data in turn according to the priority parameter, whether a lane change occurs in the target area;
if it is determined based on the road association data that the lane change occurs in the target area, determining the area in which the lane change occurs as the area to be updated.

11. The method according to claim 1, wherein the determining, based on the plurality of driving tracks and the current road condition image, target lane-level data corresponding to the area to be updated, comprises:
performing an aggregation operation on the plurality of driving tracks to obtain an aggregated track image, and determining, based on the aggregated track image, a passable area corresponding to the area to be updated;
determining a passable width corresponding to the passable area, and determining, based on the current road condition image, the number of lanes corresponding to the area to be updated;
determining, based on the passable width and the number of lanes, a lane width corresponding to each lane corresponding to the area to be updated; and
determining the passable area and the lane width corresponding to the passable area as target lane level data corresponding to the area to be updated.

12. The method according to claim 11, wherein the determining, based on the aggregated track image, a passable area corresponding to the area to be updated, comprises:
calculating an image gradient corresponding to the aggregated track image; and
performing, based on the image gradient, a cropping operation on an area of the aggregated track image that satisfies a preset cropping condition, to obtain the passable area.

13. The method according to claim 11, wherein determining, based on the passable width and the number of lanes, a lane width corresponding to each lane corresponding to the area to be updated, comprises:
dividing, according to the number of lanes, the passable width equally, and determining the lane width corresponding to each of the lanes.

14. An electronic device, comprising:
at least one processor; and
a memory communicatively coupled to the at least one processor; wherein
the memory stores instructions executable by the at least one processor, and the instructions are executed by the at least one processor to enable the at least one processor to perform the following steps:
obtaining at least one kind of road association data corresponding to a target area, wherein the road association data comprises a road condition image, a driving track, and a standard map associated with the target area;
determining, based on the at least one kind of road association data and a preset parameter associated with the road association data, at least one area to be updated in which a lane change exists in the target area;
obtaining, for each of the areas to be updated, a plurality of driving tracks corresponding to the area to be updated and a current road condition image; and
determining, based on the plurality of driving tracks and the current road condition image, target lane-level data corresponding to the area to be updated, and performing, based on the target lane-level data, an updating operation on pre-stored lane-level data.

15. The electronic device according to claim 14, wherein the preset parameter associated with the road association data comprises a weight parameter;
wherein the processor executing the step of the determining, based on the at least one kind of road association data and the preset parameter associated with the road association data, at least one area to be updated in which a lane change exists in the target area, further comprises executing the following steps:
determining, for each road association data, based on the road association data, a current road characteristic of the target area;
determining, based on the road characteristic and pre-stored historical standard data corresponding to the target area, changing content corresponding to the target area;
determining, based on a preset mapping relationship table, confidence information corresponding to the changing content, wherein the mapping relationship table comprises a mapping relationship between a plurality of changing contents and confidence;
performing, based on the confidence information corresponding to respective changing content and the weight parameter corresponding to the road association data, a weighted calculation to obtain a changing score corresponding to the target area; and
determining, based on the changing score and a preset score threshold, at least one area to be updated in which a lane change exists in the target area.

16. The electronic device according to claim 15, wherein the processor executing the step of the determining, based on the changing score and a preset score threshold, at least one area to be updated in which a lane change exists in the target area, further comprises executing the following step:
if the changing score is greater than the score threshold, determining a target changing content in the changing content that meets a preset filtering condition and taking an area corresponding to the target changing content as the area to be updated; or
if the changing score is less than the score threshold, determining that an area to be updated in which a lane changes does not exist currently in the target area.

17. The electronic device according to claim 15, wherein the road association data comprises the road condition image:
wherein the processor executing the step of the determining, based on the road association data, a current road characteristic of the target area, further comprises executing the following steps:
determining lane description information corresponding to each lane in the road condition image, wherein the lane description information comprises one or more of the number of lanes in the road condition image, position information between each lane and a socialized vehicle used for data collection, and obstacle information corresponding to each lane; and
determining, based on the lane description information, whether accuracy of the lane description information corresponding to any one of the target lanes not satisfying a preset condition exists in the target area;
if the accuracy of the lane description information corresponding to any one of the target lanes not satisfying the preset condition exists in the target area, continuing to obtain the road condition image, determining the lane description information, of which the accuracy satisfies a preset condition, corresponding to the target lane, until each lane in the target area satisfies the preset condition, and determining the road characteristic based on the lane description information, of which the accuracy satisfies a preset condition, corresponding to each lane, wherein the road characteristic comprises one or more of the number of lanes, a lane direction, a lane position, and a lane obstruction.

18. The electronic device according to claim 17, wherein the historical standard data comprises historical lane-level data; and
wherein the processor executing the step of the determining, based on the road characteristic and the pre-stored historical standard data corresponding to the target area, changing content corresponding to the target area, further comprises executing the following steps:
determining standard lane-level data matching the target area in the historical lane-level data; and
performing a comparison operation between the road characteristic and the standard lane-level data and determining the changing content based on a comparison result.

19. The electronic device according to claim 15, wherein the road association data comprises a driving track within a preset time range; and
wherein the processor executing the step of the determining, based on the road association data, a current road characteristic of the target area, further comprises executing the following steps:
performing a track aggregation operation on driving tracks to obtain an aggregated track corresponding to the target area;
identifying a drivable width and/or a driving flux and/or a driving direction corresponding to the aggregated track; and
determining the drivable width and/or the driving flux and/or the driving direction as the current road characteristic of the target area.

20. A non-transient computer readable storage medium storing computer instructions, wherein the computer instructions are configured to enable a computer to perform the following steps:
obtaining at least one kind of road association data corresponding to a target area, wherein the road association data comprises a road condition image, a driving track, and a standard map associated with the target area;
determining, based on the at least one kind of road association data and a preset parameter associated with the road association data, at least one area to be updated in which a lane change exists in the target area;
obtaining, for each of the areas to be updated, a plurality of driving tracks corresponding to the area to be updated and a current road condition image; and
determining, based on the plurality of driving tracks and the current road condition image, target lane-level data corresponding to the area to be updated, and performing, based on the target lane-level data, an updating operation on pre-stored lane-level data.
